(19) United States
(12) Patent Application Publication
(10) Pub. No.: US 2018/0123450 A1
(43) Pub. Date: May 3, 2018

(54) SWITCHING REGULATOR AND CONTROLLER THEREOF

(71) Applicant: SAMSUNG ELECTRONICS CO., LTD., SUWON-SI (KR)

(72) Inventors: YOUNG-JIN MOON, SEOUL (KR); CHANG-SIK YOO, SEOUL (KR); MIN-GYU JEONG, SEOUL (KR); KOOK-DONG KIM, SEOUL (KR)

(73) Assignees: SAMSUNG ELECTRONICS CO., LTD., SUWON-SI (KR); INDUSTRY-UNIVERSITY COOPERATION FOUNDATION HANYANG UNIVERSITY, SEOUL (KR)

(21) Appl. No.: 15/492,082

(22) Filed: Apr. 20, 2017

(30) Foreign Application Priority Data
Nov. 3, 2016 (KR) 10-2016-0145828

(51) Int. Cl. H02M 3/04; H02M 1/00

(52) U.S. Cl. CPC H02M 3/04; H02M 2001/0025; H02M 1/00

(57) ABSTRACT

A switching regulator includes an inductor connected to an output terminal of the switching regulator, a switching circuit configured to supply a current from an input terminal of the switching regulator to the inductor in response to an activated control signal, and an RC circuit including a sense resistor and a sense capacitor and connected to the inductor in parallel, the sense resistor and the sense capacitor being connected to each other in series at a feedback node.

### CROSS-REFERENCE TO RELATED APPLICATION

This U.S. non-provisional application claims the benefit of priority under 35 U.S.C. § 119 to Korean Patent Application No. 10-2016-0145828, filed on Nov. 3, 2016, in the Korean Intellectual Property Office (KIPO), the disclosure of which is incorporated herein in its entirety by reference.

### BACKGROUND

Various example embodiments of the inventive concepts relate to a switching regulator device and/or system, and more particularly, to a switching regulator, a controller of the switching regulator, a method of controlling the switching regulator, and/or a non-transitory computer readable medium for controlling the switching regulator.

A switching regulator may refer to a device that generates an output voltage from an input voltage via an ON/OFF operation, and a switched-mode power supply (SMPS) may refer to a power supply including such a switching regulator. The switching regulator may have high power efficiency and provide various output voltages, and thus, it is used to generate power voltages for different parts in various electronic systems. Particularly, there is a great desire for switching regulators used in portable electronic devices to have a small size as well as reliable and/or stable operation.

### SUMMARY

Various example embodiments of the inventive concepts provide a switching regulator employing small-sized elements, a controller of the switching regulator, a method of controlling the switching regulator, and/or a non-transitory computer readable medium for controlling the switching regulator.

According to an aspect of at least one example embodiment of the inventive concepts, there is provided a controller of a switching regulator, wherein the switching regulator includes an inductor connected to at least one output terminal of the switching regulator, a switching circuit configured to supply a current from at least one input terminal of the switching regulator to the inductor based on a control signal, and an RC circuit including at least one sense resistor connected in series to at least one sense capacitor and a feedback node, the RC circuit connected in parallel to the inductor; and the controller includes a first comparator configured to generate a first comparison signal based on a voltage of the feedback node and a first reference voltage, a first counter configured to count active pulses of the first comparison signal, and a control signal generator configured to generate the control signal based on a value of an output signal of the first counter and a first reference value.

According to another aspect of at least one example embodiment of the inventive concepts, there is provided a switching regulator including an inductor connected to an output terminal, an RC circuit connected in parallel to the inductor, the RC circuit comprising at least one sense resistor in series to at least one sense capacitor and a feedback node, a switching circuit configured to supply a current from an input terminal to the inductor based on a control signal, and a controller configured to generate the control signal based on a number of times a voltage of the feedback node intersects at least one reference voltage.

According to another aspect of at least one example embodiment of the inventive concepts, there is provided a switching regulator for a power supply, the switching regulator including an RC circuit configured to detect a current flowing through an inductor and transmit a feedback voltage based on the detected current, the RC circuit including at least one sense resistor and at least one sense capacitor, the RC circuit in parallel with an inductor, and the inductor further connected to an output terminal, an output capacitor, and a switching circuit, a controller configured to generate a control signal based on a number of times that the feedback voltage deviates from a desired voltage range, the desired voltage range defined by at least one reference voltage, and the switching circuit is configured to control the inductor based on the generated control signal, the controlling including supplying a current from an input terminal to the inductor based on the generated control signal.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a schematic circuit diagram of a switching regulator according to at least one example embodiment of the inventive concepts;

FIG. 2 is a block diagram of the controller of FIG. 1 according to at least one example embodiment of the inventive concepts;

FIG. 3 shows signal waveforms of FIGS. 1 and 2 according to at least one example embodiment of the inventive concepts;

FIGS. 4A and 4B are block diagrams showing examples of the control signal generator of FIG. 2 according to some example embodiments of the inventive concepts;

FIG. 5 is a schematic circuit diagram of a switching regulator according to at least one example embodiment of the inventive concepts;

FIG. 6 is a block diagram of a comparison circuit and a reset signal generator of FIG. 5 according to at least one example embodiment of the inventive concepts;

FIG. 7 shows signal waveforms of FIG. 6 according to at least one example embodiment of the inventive concepts;

FIG. 8 is a schematic circuit diagram of a switching regulator according to at least one example embodiment of the inventive concepts;

FIG. 9 is a block diagram of a controller 300″ of FIG. 8 according to at least one example embodiment of the inventive concepts;

FIGS. 10A and 10B are block diagrams showing examples of a control signal generator of FIG. 9 according to some example embodiments of the inventive concepts;

FIG. 11 shows signal waveforms of FIGS. 8 and 9 according to at least one example embodiment of the inventive concepts;

FIG. 12 is a flowchart of a method of controlling a switching regulator according to an at least one example embodiment of the inventive concepts;

FIG. 13 is a flowchart of an example of operation S40 of FIG. 12 according to at least one example embodiment of the inventive concepts; and

FIG. 14 is block diagram of a system including a switching regulator according to at least one example embodiment of the inventive concepts.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

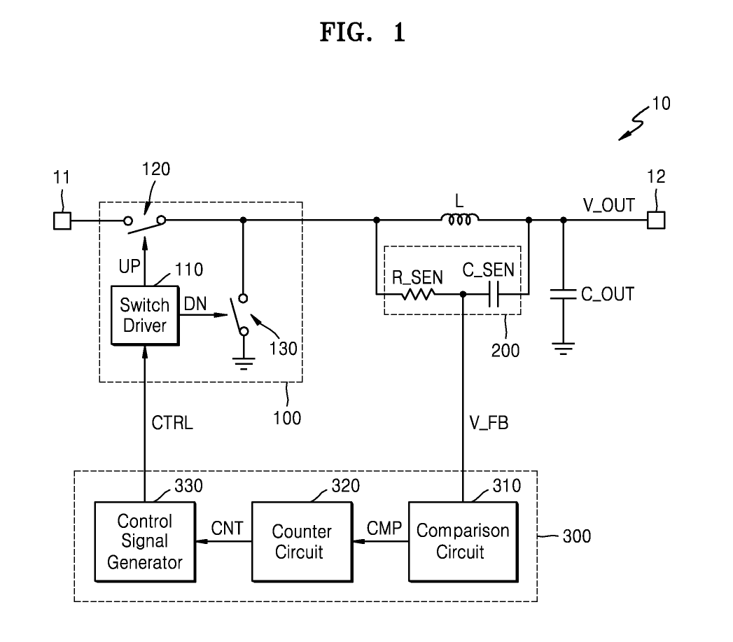

FIG. 1 is a schematic circuit diagram of a switching regulator 10 according to at least one example embodiment of the inventive concepts. The switching regulator 10 may include a plurality of elements and sub-circuits and may output power via an output terminal 12. The output power is regulated from electrical power supplied via an input terminal 11.

As shown in FIG. 1, the switching regulator 10 according to at least one example embodiment of the inventive concepts may be a DC-DC (e.g., a direct current to direct current) converter such as a buck converter or a step-down converter. In other words, the switching regulator 10 may generate an output voltage V_OUT that is lower than a voltage applied to the input terminal 11. The switching regulator 10 may be widely used in various applications, such as an audio speaker driver, a portable mobile device, an LED driver, an LCD bias circuit, etc. Hereinafter, various example embodiments of the inventive concepts will be described mainly with reference to a switching regulator 10 that is a buck converter, but it will be understood that the technical spirit of the inventive concepts are not limited thereto.

The buck converter of FIG. 1 may adjust a switch timing of an element that controls a current supplied from the input terminal 11 to an inductor L based on a feedback loop. For example, from among a plurality of schemes for controlling the buck converter, a voltage-mode control scheme may control a current supplied to the inductor L in response to a variation of an output voltage V_OUT. Furthermore, from among a plurality of schemes for controlling the buck converter, a current-mode control scheme may control a current supplied to the inductor L in response to a variation of a current flowing through the inductor L. According to at least one example embodiment, buck converters that are controlled according to the current-mode control scheme will be described.

The buck converter may include elements capable of accumulating and/or storing energy, such as the inductor L, capacitors C_SEN and C_OUT, etc. The inductor L and the capacitors C_SEN and C_OUT may have relatively large physical sizes in comparison to with circuit components, such as a transistor, a resistor, etc. The larger the inductance capacity of the inductor L and the capacitances capacity of the capacitors C_SEN and C_OUT are, the larger the size of the inductor L and the size of capacitors C_SEN and C_OUT may physically be. Therefore, it is important to miniaturize such elements capable of accumulating and/or storing energy, when they are arranged in the same physical package as circuit components (e.g., the transistor or resistor, etc.) or when they are arranged on a printed circuit board (PCB), as elements of the switching regulator 10 to be used as a power supply for a an electronics system, such as a mobile electronic device, a smartphone, a tablet, a wearable device, an Internet of Things (IoT) device, a virtual reality device, etc., where physical space may be at a premium. As described below, the switching regulator 10 may be miniaturized by reducing the sizes of the constituent elements used in the switching regulator 10, and deviations of the elements may be easily compensated for according to various example embodiments of the inventive concepts, and thus the utilization of the switching regulator 10 may be improved. Furthermore, according to at least one example embodiment of the inventive concepts, due to a reduced capacitance of the switching regulator 10, noise transmitted from the input terminal 11 to the output terminal 12 may be reduced, and an offset occurring at the output voltage V_OUT may be eliminated.

Referring to FIG. 1, the switching regulator 10 may include a switching circuit 100, an RC circuit 200, a controller 300, and a plurality of passive elements including the inductor L and the output capacitor C_OUT, but is not limited thereto. The inductor L may have a first end connected to the output terminal 12 and the output capacitor C_OUT, and a second end connected to the switching circuit 100. A current flowing through the inductor L may be supplied from the input terminal 11, or may flow from the inductor L to the ground depending on the switching operations of the switching circuit 100.

The switching circuit 100 may supply a current from the input terminal 11 to the inductor L, or cause a current to flow from the inductor L to the ground based on a control signal CTRL. The output voltage V_OUT may increase (e.g., rise) when a current is supplied to the inductor L from the input terminal 11. On the contrary, the output voltage V_OUT may decrease (e.g., lower) when a current flows from the inductor L to the ground. As shown in FIG. 1, the switching circuit 100 may include a switch driver 110, first and second switches 120 and 130, etc.

The switch driver 110 may generate an up signal UP and a down signal DN according to (and/or based on) the control signal CTRL. The first switch 120 may interconnect (e.g., close) the input terminal 11 and the inductor L in response to receiving the activated up signal UP, whereas the second switch 130 may interconnect (e.g., close) the ground and the inductor L in response to receiving the activated down signal DN. An activated signal may have a voltage level different from that of a deactivated signal. For example, an activated signal may have a higher or lower voltage than a deactivated signal. Although it is described herein that an activated signal has a higher voltage than a deactivated signal, it would be obvious that the technical spirit of the inventive concepts are not limited thereto.

The switch driver 110 may activate the up signal UP in response to the activated control signal CTRL, and may activate the down signal DN in response to the deactivated control signal CTRL. Furthermore, according to at least one example embodiment, the switch driver 110 may exclusively generate the activated up signal UP and the activated down signal DN. In other words, the switch driver 110 may generate the up signal UP and the down signal DN, such that the up signal UP and the down signal DN are not activated at the same time. Furthermore, the switch driver 110 may add a dead time of an appropriate/desired length of time between the deactivation of a signal and the activation of another signal in order to avoid instances where both the first switch 120 and the second switch 130 are activated.

According to at least one example embodiment, the RC circuit 200 may be connected to the inductor L in parallel as shown in FIG. 1 and may include at least one sense resistor R_SEN, at least one sense capacitor C_SEN, etc., that are connected in series. In other words, the sense resistor R_SEN may have a first end connected to one terminal of the inductor L and a second end connected to the sense capacitor C_SEN, whereas the sense capacitor C_SEN may have a first end connected to one terminal of the inductor L and a second end connected to the sense resistor R_SEN, but the example embodiments are not limited thereto. The RC circuit 200 connected to the inductor L in parallel is a circuit for sensing a current flowing through the inductor L. A node to which the sense resistor R_SEN and the sense capacitor C_SEN are connected may be referred to as a feedback node and, as shown in FIG. 1, a voltage of the feedback node, that is, a feedback voltage V_FB may be provided to the controller 300. As described below, in the controller 300, the feedback voltage V_FB may be compared to a reference voltage, and the current supplied to the inductor L may be controlled according to a result of the comparison.

According to at least one example embodiment of the inventive concepts, the sense capacitor C_SEN of the RC circuit 200 may have a reduced capacitance. For example, the sense capacitor C_SEN may have a high capacitance capacity, e.g., tens to hundreds of pF, to sense (e.g., detect) a signal having a same phase as a current through the inductor L. Therefore, the sense capacitor C_SEN may have a large physical size, and thus, the size of a package including the sense capacitor C_SEN is increased and/or physical space may be wasted if the sense capacitor C_SEN is disposed on a printed circuit board as a discrete element. Additionally, some hardware designers may elect to omit the sense capacitor due to the size restriction of the package, printed circuit board, etc. However, as described below, according to at least one example embodiment of the inventive concepts, the controller 300 generates the control signal CTRL based on a number of times the feedback voltage V_FB intersects the reference voltage, and thus, a capacitance capacity of the sense capacitor C_SEN may be reduced.

The controller 300 may receive the feedback voltage V_FB and may generate the control signal CTRL. As shown in FIG. 1, the controller 300 may include a comparison circuit 310, a counter circuit 320, and a control signal generator 330, but is not limited thereto. The comparison circuit 310 may generate at least one comparison signal CMP by comparing the feedback voltage V_FB to at least one reference voltage (e.g., a desired voltage, a threshold voltage, etc.). The counter circuit 320 may count active pulses of the at least one comparison signal CMP output by the comparison circuit 310. In other words, the counter circuit 320 may count the number of times the feedback voltage V_FB intersects the at least one reference voltage. According to at least one example embodiment, when a value of a count signal CNT output by the counter circuit 320 exceeds a reference count, the control signal generator 330 may activate or deactivate the control signal CTRL. In other words, the control signal generator 330 may activate or deactivate the control signal CTRL based on the count signal CNT. As described above, the controller 300 may generate the control signal CTRL based on the number of times the feedback voltage intersects with the reference voltage, and thus the sense capacitor C_SEN may have a low capacitance capacity and therefore may have a reduced physical size.

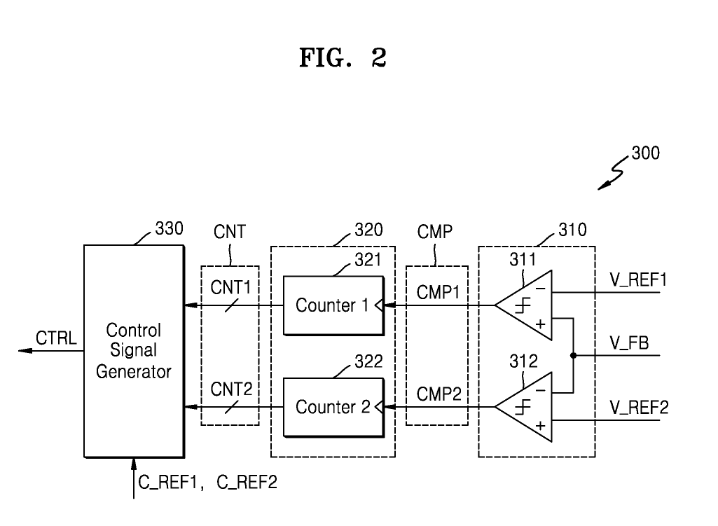

FIG. 2 is a block diagram of the controller 300 of FIG. 1 according to at least one example embodiment of the inventive concepts. As described above with reference to FIG. 1, the controller 300 may include the comparison circuit 310, the counter circuit 320, and the control signal generator 330, etc., and may generate the control signal CTRL from the feedback voltage V_FB.

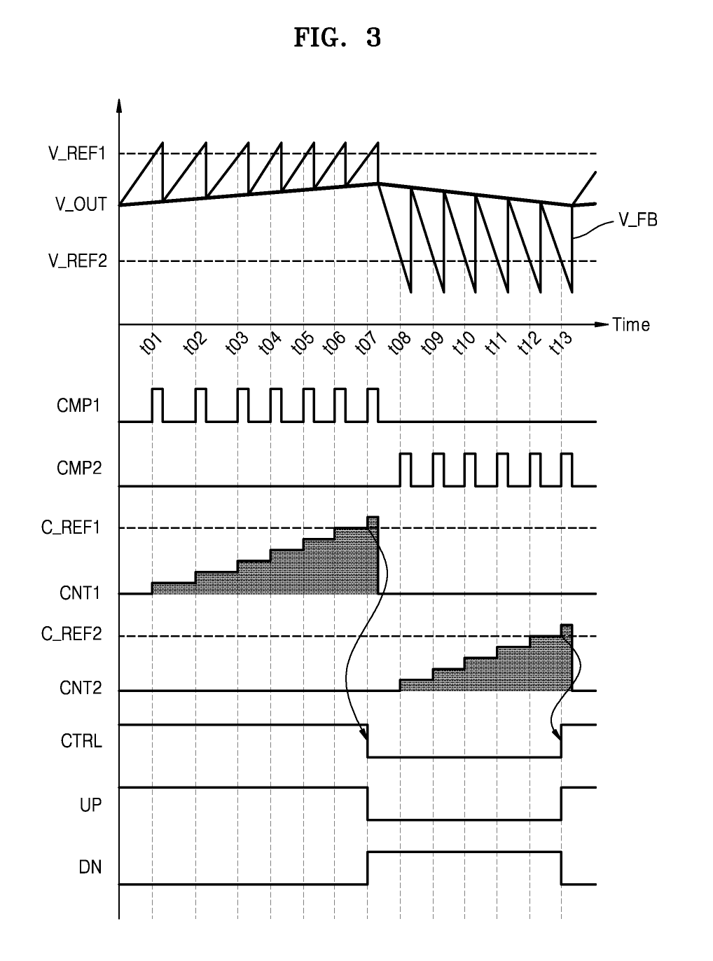

Referring to FIG. 2, the comparison circuit 310 may include a first comparator 311 and a second comparator 312, but is not limited thereto. The first comparator 311 may generate a first comparison signal CMP1 by comparing the feedback voltage V_FB to a first reference voltage V_REF1, whereas the second comparator 312 may generate a second comparison signal CMP2 by comparing the feedback voltage V_FB to a second reference voltage V_REF2. As described below with reference to FIG. 3, the first and second reference voltages V_REF1 and V_REF2 may correspond to the upper and lower limits of the feedback voltage V_FB, respectively. For example, the first reference voltage V_REF1 may be higher than the second reference voltage V_REF2 and, when the feedback voltage V_FB is higher than the first reference voltage V_REF1 (that is, the activated first comparison signal CMP1 is output), it may indicate that a current is supplied to the inductor L from the input terminal 11. Furthermore, when the feedback voltage V_FB is lower than the second reference voltage V_REF2 (that is, the activated second comparison signal CMP2 is output), it may indicate that a current flows from the inductor L to the ground. However, the example embodiments are not limited thereto and the reference voltages, e.g., V_REF1 and V_REF2, may have any relationship to each other.

The counter 320 may include a first counter 321 and a second counter 322, but is not limited thereto. The first counter 321 may receive the first comparison signal CMP1 and may generate a first count signal CNT1 by counting the number of active pulses of the first comparison signal CMP1. The second counter 322 may also receive the second comparison signal CMP2 and may generate a second count signal CNT2 by counting the number of active pulses of the second comparison signal CMP2. In other words, a value of the first count signal CNT1 output by the first counter 321 may indicate the number of times the feedback voltage V_FB intersects with the first reference voltage V_REF1, whereas a value of the second count signal CNT2 output by the first comparator 322 may indicate the number of times feedback voltage V_FB intersects with the second reference signal V_REF2 as the feedback voltage V_FB drops.

The control signal generator 330 may receive the first and second count signals CNT1 and CNT2 from the counter circuit 320 and may generate the control signal CTRL based on the first and second count signals CNT1 and CNT2 and the first and second reference counts C_REF1 and C_REF2. For example, the control signal generator 330 may deactivate the control signal CTRL when a value of the first count signal CNT1 exceeds the first reference count C_REF1. In other words, when the number of times the feedback voltage V_FB intersects with the first reference voltage V_REF1 as the feedback voltage V_FB rises exceeds the first reference count C_REF1, the controller 300 may determine that an excess current is supplied to the inductor L, and thus the control signal generator 330 may generate the deactivated control signal CTRL. Similarly, the control signal CTRL may be activated when a value of the second count signal CNT2 exceeds the second reference count C_REF2. In other words, when the number of times the feedback voltage V_FB intersects with the second reference voltage V_REF2 as the feedback voltage V_FB drops exceeds the second reference count C_REF2, the controller 300 may determine that an excessive current flows from the inductor L to the ground, and thus the control signal generator 330 may generate the activated control signal CTRL.

The first and second reference counts C_REF1 and C_REF2 may be received from outside of the switching regulator 10 (e.g., externally). In other words, the first and second reference counts C_REF1 and C_REF2 may be adjusted outside the switching regulator 10 (e.g., from a signal from a host, etc.), and thus the switching regulator 10 may compensate for a deviation of capacitance in the sense capacitor C_SEN. For example, when a test result of the switching regulator 10 indicates that capacitance of the sensing capacitor C_SEN is lower than a desired and/or target capacitance, the first reference count C_REF1 and/or the second reference count C_REF2 may be increased. In other words, according to some example embodiments the capacitance of the sense capacitor C_SEN may be inversely proportional to the first reference count C_REF1 or the second reference count C_REF2, but is not limited thereto. Also, according to at least one example embodiment of the inventive concepts, the first and second reference counts C_REF1 and C_REF2 may be identical to each other. In this case, only one reference count may be provided to the control signal generator 330.

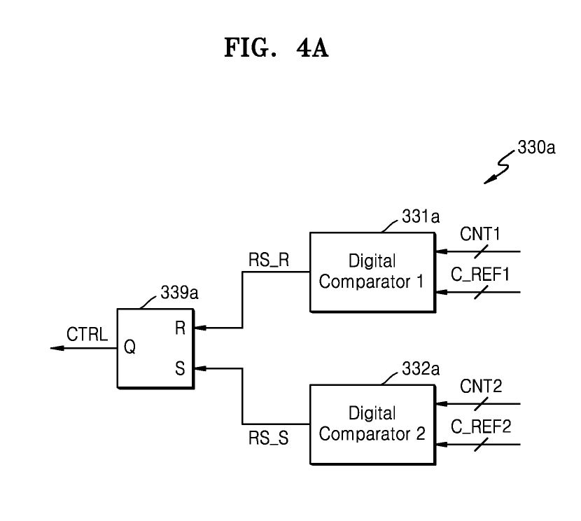

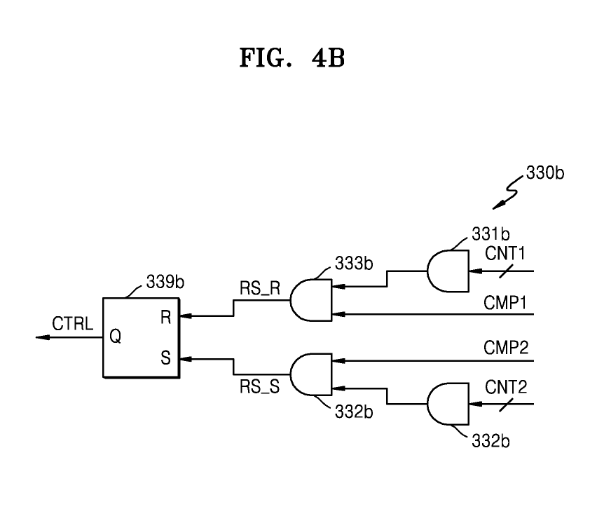

Unlike the controller 300 shown in FIG. 2, the first and second reference counts C_REF1 and C_REF2 may be set inside the control signal generator 330 according to at least one example embodiment of the inventive concepts. For example, the control signal generator 330 may include a memory for storing the first and second reference counts C_REF1 and C_REF2, where the first and second reference counts C_REF1 and C_REF2 may be stored based on a signal received from outside (e.g., a signal transmitted by an external source, such as a host, etc.). In another example embodiment, as described below with reference to FIG. 4B, the control signal generator 330 may include a logic circuit designed to output an activated signal when the first and second count signals CNT1 and CNT2 exceed a reference count. Detailed description of the control signal generator 330 will be given below with reference to FIGS. 4A and 4B.

FIG. 3 is a waveform diagram of the signals of FIGS. 1 and 2 according to at least one example embodiment of the inventive concepts. FIG. 3 shows that an activated signal has a high level and a deactivated signal has a low level. Furthermore, FIG. 3 shows that levels of the first and second count signals CNT1 and/or CNT2 rise as more (e.g., additional) active pulses (e.g., VV_REF1 or V_REF2) are counted. However, according to other example embodiments and unlike the waveform diagram shown in FIG. 3, the first and second count signals CNT1 and CNT2 may be digital signals including a plurality of bit signals and the first and second count signals CNT1 and CNT2 may have digital values that increase as more and more active pulses are counted. In the example embodiment shown in FIG. 3, it is assumed that the first reference count C_REF1 is ‘6’ and the second reference count C_REF2 is ‘5’. Hereinafter, descriptions of FIG. 3 will be given with reference to FIGS. 1 and 2.

Referring to FIG. 3, at time points t01 through t07, the up signal UP is activated due to (and/or based on) the activated control signal CTRL, and a current is supplied from the input terminal 11 to the inductor L according to the activated up signal UP. As a result, the output voltage V_OUT is continuously increased. The feedback voltage V_FB rises due to the current supplied to the inductor L and intersects with and/or passes the value of the first reference voltage V_REF1. For example, the feedback voltage V_FB intersects with the first reference voltage V_REF1 at time point t01 (that is, the feedback voltage V_FB may be greater than or equal to the first reference voltage V_REF1), and thus the first comparison signal CMP1 is activated. Then, the value of the first count signal CNT1 increases in response to the activated first comparison signal CMP1. Similarly, the first comparison signal CMP1 is activated at time points t02, t03, t04, t05 and t06, respectively, and thus the value of the first count signal CNT1 increases at the time points t02, t03, t04, t05 and t06.

At the time point t07, as the feedback voltage V_FB rises, the feedback voltage V_FB intersects with and/or passes the value of the first reference voltage V_REF1, and thus the first comparison signal CMP1 is activated. In response to the activated first comparison signal CMP1, the value of the first count signal CNT1 may increase to ‘7’. Therefore, the value of the first count signal CNT1 may exceed the first reference count C_REF1 (that is, ‘6’), and the control signal generator 330 deactivates the control signal CTRL. Due to the deactivated control signal CTRL, the up signal UP is deactivated and the down signal DN is activated. As the inductor L is connected to the ground, a current flows from the inductor L to the ground, and thus, the output voltage V_OUT is reduced.

As the current flows from the inductor L to the ground, the feedback voltage V_FB drops and intersects with and/or passes the value of the second reference voltage V_REF2. For example, at a time point t08, as the feedback voltage V_FB drops, the feedback voltage V_FB intersects with the second reference voltage V_REF2 (that is, the feedback voltage V_FB may be lower than or equal to the second reference voltage V_REF2), and thus the second comparison signal CMP2 is activated. In response to the activated second comparison signal CMP2, the second count signal CNT2 increases. Similarly, the second comparison signal CMP2 is activated at time points t09, t10, t11, and t12, respectively, and thus the second count signal CNT2 is increased at the time points t09, t10, t11, and t12.

At a time point t13, the second comparison signal CMP2 may be activated as the feedback voltage V_FB intersects with and/or passes the second reference voltage V_REF2, and the value of the second count signal CNT2 increases to ‘6’ in response to the activated second comparison signal CMP2. Therefore, the value of the second count signal CNT2 may exceed the second reference count C_REF2 (that is, ‘5’), and the control signal generator 330 activates the control signal CTRL. Due to the activated control signal CTRL, the up signal UP is activated and the down signal DN is deactivated. As the inductor L is connected to the input terminal 11, a current is supplied from the input terminal 11 to the inductor L, and thus the output voltage V_OUT is increased again.

FIGS. 4A and 4B are block diagrams showing examples 330a and 330b of the control signal generator 330 of FIG. 2 according to at least one example embodiment of the inventive concepts. As described above with reference to FIGS. 2 and 3, the control signal generators 330a and 330b may receive the count signals CNT from the counter circuit 320 and may generate control signals CTRL based on the count signals CNT.

Referring to FIG. 4A, the control signal generator 330a may include a first digital comparator 331a, a second digital comparator 332a, and an RS latch 339a, but is not limited thereto. The first digital comparator 331a may generate a RS reset signal RS_R based on the values of the first count signal CT1 and the first reference count C_REF1. For example, when the value of the first count signal CNT1 is greater than or equal to the first reference count C_REF1, the first digital comparator 331a may generate the activated RS reset signal and the RS latch 339a may output the deactivated control signal CTRL in response to the activated RS reset signal RS_R. According to at least one example embodiment, the deactivated control signal CTRL may be input to the switching circuit 100 of FIG. 1 and the switching circuit 100 may cause a current to flow from the inductor L to the ground in response to the deactivated control signal CTRL.

Similarly, the second digital comparator 332a may generate the RS set signal RS_S by comparing the second count signal CNT2 to the second reference count C_REF2. In other words, the second digital comparator 332a may generate the activated RS set signal RS_S based on the values of the second count signal CT2 and the second reference count C_REF2, for example when the value of the second count signal CNT2 is equal to or greater than the second reference count C_REF2, and the RS latch 339a may output the activated control signal CTRL in response to the activated RS set signal RS_S. The activated control signal CTRL may be input to the switching circuit 100 of FIG. 1 and the switching circuit 100 may cause a current to flow from the input terminal 11 to the inductor in response to the activated control signal CTRL.

According to at least one example embodiment of the inventive concepts, the first and second comparators 331a and 332a may generate active pulses (e.g., outputting a high and/or enabled signal for a desired period of time), but is not limited thereto. In other words, the first and second comparators 331a and 332a may generate active pulses that are deactivated after being activated according to the results of the respective comparisons. For example, the first comparator 331a may generate an active pulse of the RS reset signal RS_R when the first count signal CNT1 is greater than or equal to the first reference count C_REF1, whereas the second comparator 332a may generate an active pulse of the RS set signal RS_S when the second count signal CNT2 is greater than or equal to the second reference count C_REF2.

Referring to FIG. 4B, the control signal generator 330b may include a plurality of AND gates 331b through 334b and a RS latch 339b, but is not limited thereto. A first AND gate 331b may receive the first count signal CNT1 including a plurality of bit signals and, when all of the bit signals of the first count signal CNT1 are activated (e.g., the values of all of the bit signals become ‘1’), may output an activated signal. For example, when the first counter 321 of FIG. 2 is a 4-bit counter, the first count signal CNT1 may, for example, include a four-bit signal (e.g., four single-bit signals) and, when values of all four bit signals become ‘1’ (that is, the first counter 321 counts 15 active pulses of the first comparison signal CMP1), the first AND gate 331b may output an activated signal. Accordingly, when the first count signal CNT1 includes four bit signals, the first reference count C_REF1 of FIG. 2 may be ‘14’, and the control signal generator 330b of FIG. 4B may internally determine the first reference count C_REF1 by using a logic circuit instead of receiving the first reference count C_REF1 from outside. However, the example embodiments are not limited thereto and the first signal CNT1 (and/or any other signals) may be any number of bits wide and the associated logic gates and/or circuits will be of corresponding bit-width. Similarly, a second AND gate 332b may also output an activated signal when all of the bit signals of the second count signal CNT2 are activated (that is, values of all of the bit signals of the second count signal CNT2 become ‘1’).

A third AND gate 333b may receive the output signal of the first AND gate 331b and the first comparison signal CMP1 and may output the RS reset signal RS_R based on the received input signals. In other words, the third AND gate 333b performs an AND operation on the output signal of the first AND gate 331b, which is activated while all of the bit signals of the first count signal CNT1 are being activated, and the first comparison signal CMP1, thereby outputting the RS reset signal RS_R as having an active pulse. For example, when the first count signal CNT1 includes four bit signals as described above, the output signal of the first AND gate 331b may be activated by the fifteenth active pulse of the first comparison signal CMP1, and thus an active pulse of the RS reset signal RS_R may be generated as a pulse width corresponding to a desired period in which the output signal of the first AND gate 331b and the fifteenth active pulse of the first comparison signal CMP1 are both activated. Similarly, a fourth AND gate 334b may also generate the RS set signal RS_S having an active pulse when all bit signals of the second count signal CNT2 are activated.

According to at least one example embodiment of the inventive concepts, the input signals of the RS latch 339a or 330b, that is, the RS reset signal RS_R and the RS set signal RS_S, may be used to reset the counter circuit 320 of FIG. 2. For example, the RS reset signal RS_R may be input to the reset terminal of the first counter 321, whereas the RS set signal RS_S may be input to the reset terminal of the second counter 322. Therefore, when the values of the counter signals CNT1 and/or CNT2 exceed a desired reference count, the counter signals CNT1 and CNT2 may be initialized (or reset) by the input signals of the RS latch 339a and/or 330b. In other words, values of the counter signals CNT1 and CNT2 may be set to ‘0’.

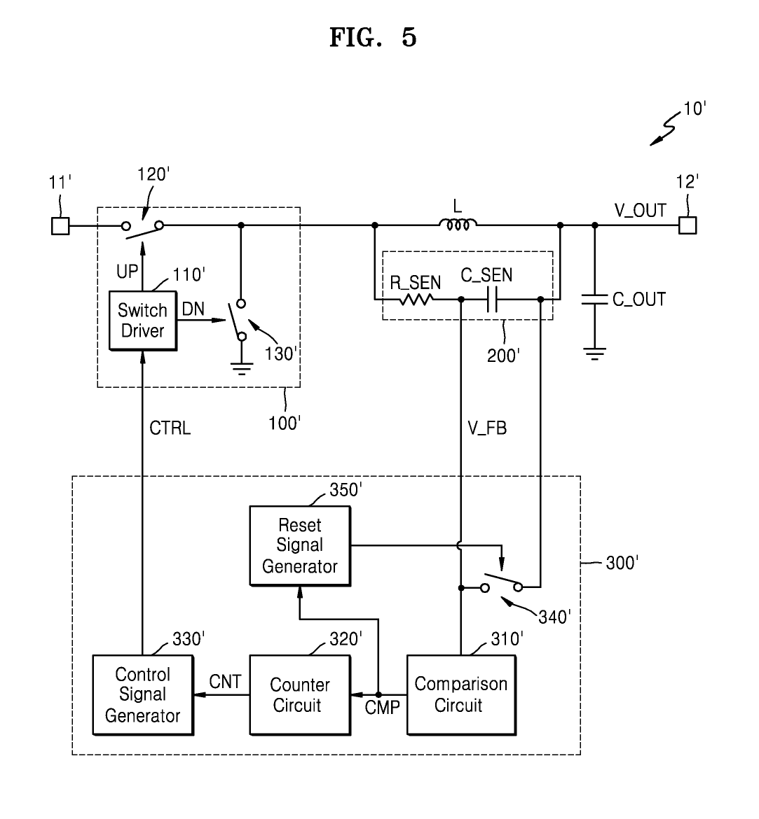

FIG. 5 is a schematic circuit diagram of a switching regulator 10′ according to at least one example embodiment of the inventive concepts. Similar to the switching regulator 10 of FIG. 1, the switching regulator 10′ of FIG. 5 includes a switching circuit 100′, an RC circuit 200′, a controller 300′, and a plurality of passive elements including the inductor L and the output capacitor C_OUT, but is not limited thereto.

Referring to FIG. 5, the controller 300′ includes a comparison circuit 310′, a counter circuit 320′, a control signal generator 330′, a reset switch 340′, and a reset signal generator 350′, but is not limited thereto. The controller 300′ of FIG. 5 may further include the reset switch 340′ and the reset signal generator 350′ as compared to the controller 300 of FIG. 1, and the comparison circuit 310′, the counter circuit 320′, and the control signal generator 330′ may perform functions identical or similar to those of the comparison circuit 310, the counter circuit 320, and the control signal generator 330 of FIG. 1.

The reset switch 340′ connects to both ends of the sense capacitor C_SEN and may close in response to an activated reset signal RST, and may open in response to a deactivated reset signal RST. Therefore, when the reset switch 340′ interconnects both ends of the sense capacitor C_SEN in response to the activated reset signal RST, the feedback voltage V_FB may be reset to the output voltage V_OUT.

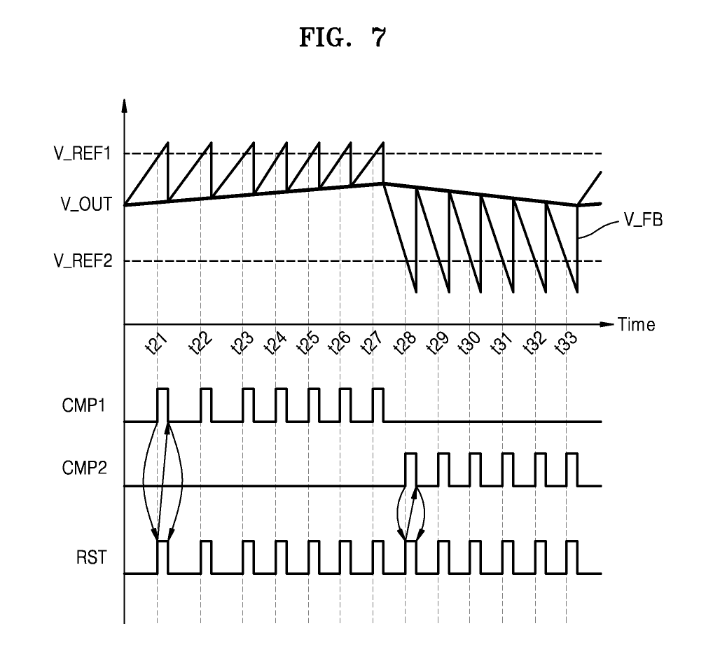

Depending on the conditions of the load connected to the output terminal 12′, charges accumulated in the sense capacitor C_SEN may differ, and such the different charges may cause an offset of the output voltage V_OUT. However, since both ends of the sense capacitor C_SEN are connected to the reset switch 340′, the offset of the output voltage V_OUT according to a condition of the load may be eliminated. Furthermore, as described below with reference to FIG. 7, a loop in which the reset signal RST is generated based on a comparison signal CMP generated by the comparison circuit 310′ and a variation of the feedback voltage V_FB due to the operation of the reset switch 340′ is provided to the comparison circuit 310′ is formed, and thus the comparison signal CMP of the comparison circuit 310′ may have a pulse that is activated and then deactivated according to a result of a comparison.

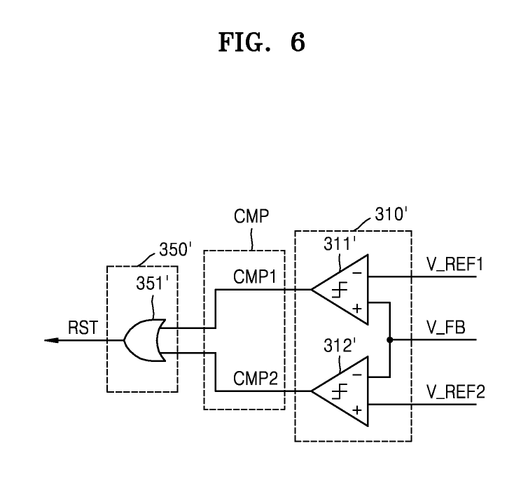

The reset signal generator 350′ may receive the comparison signal CMP from the comparison circuit 310′ and may generate the reset signal RST based on the comparison signal CMP. For example, the reset signal generator 350′ may generate the reset signal RST activated in response to the activated comparison signal CMP and generate the reset signal RST in response to the deactivated comparison signal CMP. Detailed description of the reset signal generator 350′ will be given below with reference to FIGS. 6 and 7.

FIG. 6 is a block diagram of the comparison circuit 310′ and the reset signal generator 350′ of FIG. 5 according to at least one example embodiment of the inventive concepts, and FIG. 7 shows a waveform diagram of the signals of FIG. 6 according to at least one example embodiment of the inventive concepts. As described above with reference to FIG. 5, the reset signal generator 350′ may generate the reset signal RST based on the comparison signal CMP of the comparison circuit 310′. In FIG. 7, it is assumed that an activated signal has a higher level than a deactivated signal, but the example embodiments are not limited thereto.

Referring to FIG. 6, similar to the comparison circuit 310 of FIG. 2, the comparison circuit 310′ may include first and second comparators 311′, 312′ and may generate the first and second comparison signals CMP1 and CMP2 from the first and second reference voltages V_REF1 and V_REF2, but is not limited thereto. As an example, the first reference voltage V_REF1 may be higher than the second reference voltage V_REF2, and when the feedback voltage V_FB is not between the first reference voltage V_REF1 and the second reference voltage V_REF2, or in other words, when the feedback voltage V_FB is not within a desired range, the desired range based on the first reference voltage V_REF1 and the second reference voltage V_REF2, the first comparison signal CMP1 or the second comparison signal CMP2 may be activated.

As shown in FIG. 6, the reset signal generator 350′ may include an OR gate 351′, and the OR gate 351′ may output the reset signal RST from the first and/or second comparison signals CMP1 and CMP2. In other words, the reset signal RST may be activated when the first comparison signal CMP1 or the second comparison signal CMP2 is activated. Therefore, when the feedback voltage V_FB is out of the range between the first and second reference voltages V_REF1 and V_REF2 (e.g., the feedback voltage V_FB is not within the desired range), the feedback voltage V_FB may be reset to the output voltage V_OUT by the activated reset signal RST.

Referring to FIG. 7, as the feedback voltage V_FB rises at a time point t21, the feedback voltage V_FB may intersect with the first reference voltage V_REF1 (e.g., the feedback voltage V_FB is greater than or equal to the first reference voltage V_REF1), and thus the first comparison signal CMP1 may be activated. As indicated by arrows in FIG. 7, the reset signal RST may be activated by the activated first comparison signal CMP1 and, as the feedback voltage V_FB is reset to the output voltage V_OUT in response to the activated reset signal RST, the first comparison signal CMP1 may be deactivated. Thus, the reset signal RST may be deactivated by the deactivated first comparison signal CMP1. Similarly, the first comparison signal CMP1 and the reset signal RST may have active pulses at time points t22, t23, t24, t25, t26, and t27.

At a time point t28 on FIG. 7, as the feedback voltage V_FB drops, the feedback voltage V_FB may intersect with the second reference voltage V_REF2 (e.g., the feedback voltage V_FB is less than or equal to the second reference voltage V_REF2), and thus the second comparison signal CMP2 may be activated. As indicated with arrows in FIG. 7, the reset signal RST may be activated by the activated second comparison signal CMP2 and, as the feedback voltage V_FB is reset to the output voltage V_OUT in response to the activated reset signal RST, the second comparison signal CMP2 may be deactivated and the reset signal RST may be deactivated by the deactivated second comparison signal CMP2. Similarly, at time points t29, t30, t31, t32, and t33, the second comparison signal CMP2 and the reset signal RST may have active pulses.

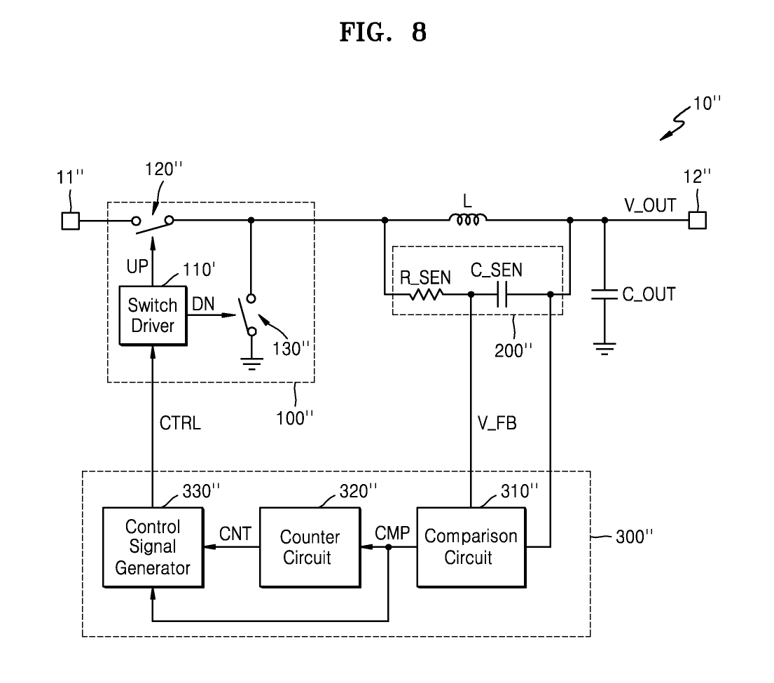

FIG. 8 is a schematic circuit diagram of a switching regulator 10″ according to at least one example embodiment of the inventive concepts. Similar to the switching regulator 10 of FIG. 1, the switching regulator 10″ may include a switching circuit 100″, an RC circuit 200″, a controller 300″, and a plurality of passive elements including the inductor L and the output capacitor C_OUT, but is not limited thereto.

Referring to FIG. 8, the controller 300″ may include a comparison circuit 310″, a counter circuit 320″, and a control signal generator 330″, but is not limited thereto. Compared with the comparison circuit 310 of FIG. 1, the comparison circuit 310″ of FIG. 8 may receive at least one additional signal, such as the output voltage V_OUT. The control signal generator 330″ of the comparison circuit 310″ may also receive additional signals, such as the comparison signal CMP generated by the comparison circuit 310″.

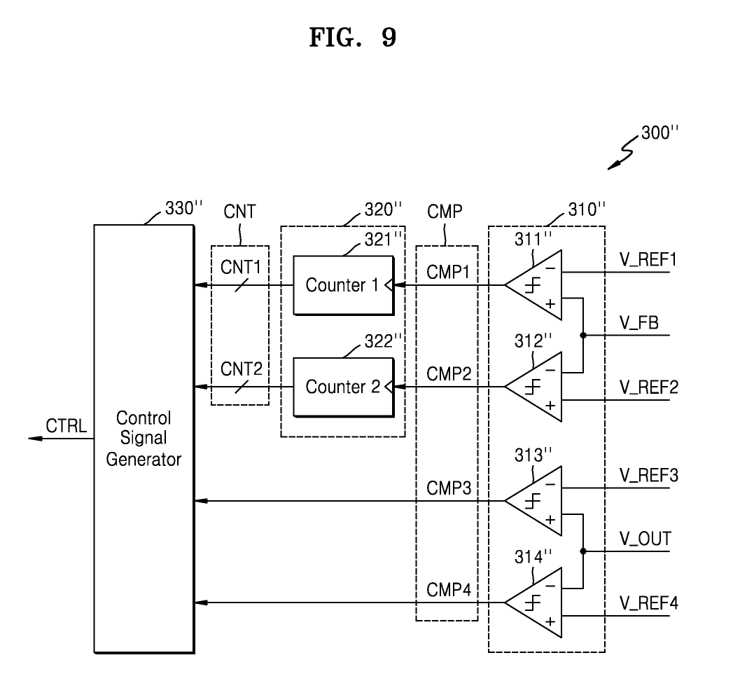

The comparison circuit 310″ may generate the at least one comparison signal CMP by comparing the output voltage V_OUT to at least one reference voltage. A reference voltage to be compared to the feedback voltage V_FB by the comparison circuit 310″ may be identical to, or different from, a reference voltage to be compared to the output voltage V_OUT by the comparison circuit 310″. In other words, the two reference voltages may have the same (or different) voltage values. Detailed description of the comparison circuit 310″ will be given below with reference to FIG. 9.

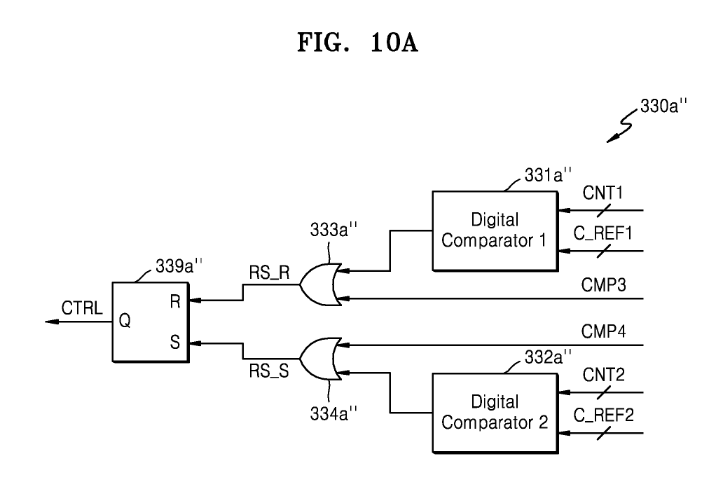

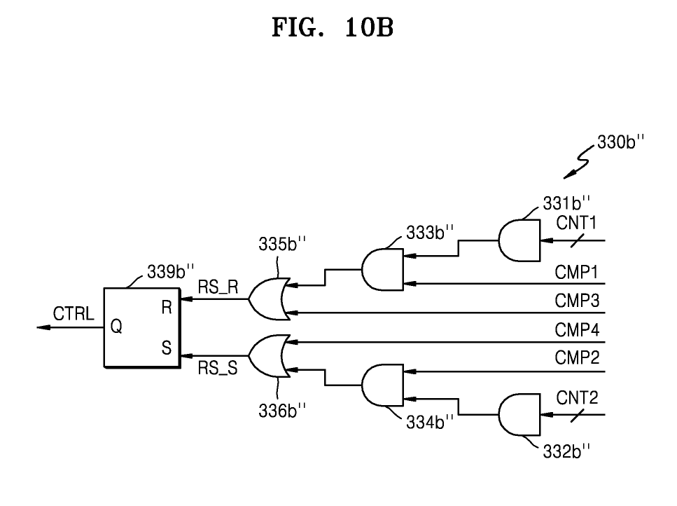

The control signal generator 330″ may generate the control signal CTRL based on not only the count signal CNT output by the counter circuit 320″, but also the comparison signal CMP output by the comparison circuit 310″. In other words, the control signal CTRL for controlling a current supplied to the inductor L may be generated based on a variation of the feedback voltage V_FB, which is a signal indicating that a current flowing through the inductor L is detected, and a variation of the output voltage V_OUT due to a load connected to the output terminal 12″. Detailed description of the control signal generator 330″ will be given below with reference to FIGS. 10A and 10B.

FIG. 9 is a block diagram of the controller 300″ of FIG. 8 according to at least one example embodiment of the inventive concepts. As shown in FIG. 9, the controller 300″ may include the comparison circuit 310″, the counter circuit 320″, and the control signal generator 330″; may receive first to fourth reference voltages V_REF1 through V_REF4, the feedback voltage V_FB, and the output voltage V_OUT; and may output the control signal CTRL, but is not limited thereto.

Referring to FIG. 9, the comparison circuit 310″ may include first to fourth comparators 311″ through 314″, but is not limited thereto. Similar to the first and second comparators 311 and 312 of FIG. 2, the first and second comparators 311″ and 312″ of FIG. 9 compare the feedback voltage V_FB to one or more reference voltages, such as the first and second reference voltages V_REF1 and V_REF2, respectively, thereby generating the first and second comparison signals CMP1 and CMP2. The third comparator 313″ may generate a third comparison signal CMP3 by comparing the output voltage V_OUT to a third reference voltage V_REF3, and the fourth comparator 314″ may generate a fourth comparison signal CMP4 by comparing the output voltage V_OUT to a fourth reference voltage V_REF4.

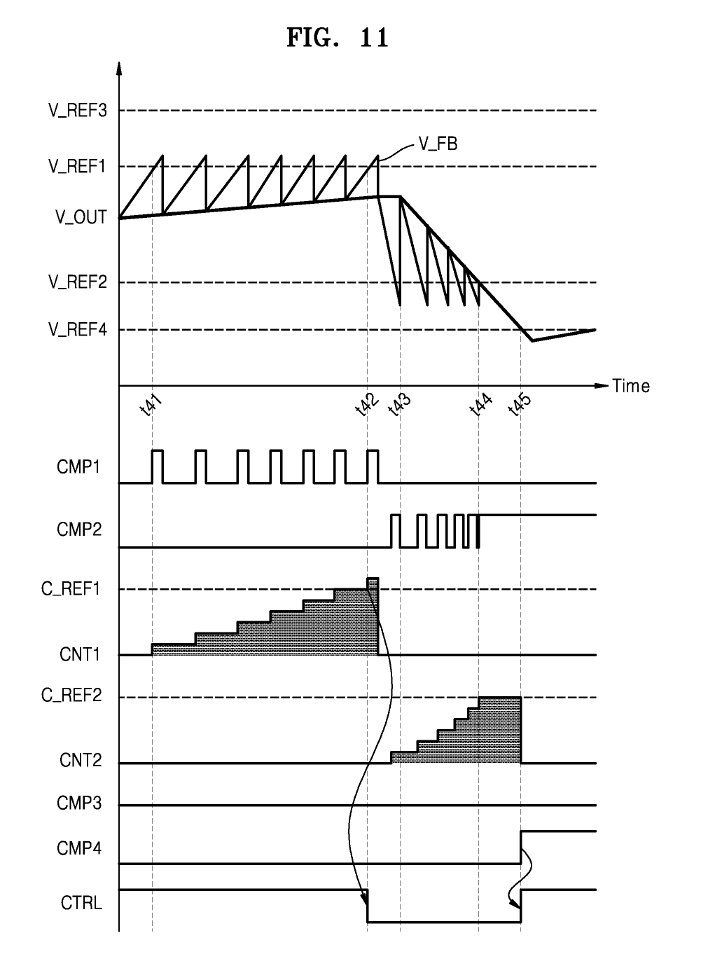

As described below with reference to FIG. 11, the third and fourth reference voltages V_REF3 and V_REF4 may, for example, correspond to the upper and lower limits of the output voltage V_OUT. For example, the third reference voltage V_REF3 may be higher than the fourth reference voltage V_REF4 and, when the output voltage V_OUT is higher than a high reference limit, e.g., the third reference voltage V_REF3 (that is, when the activated third comparison signal CMP3 is output), a current supplied from the input terminal 11″ to the inductor L may be blocked. Furthermore, when the output voltage V_OUT is lower than a lower reference limit, e.g., the fourth reference voltage V_REF4 (that is, the activated fourth comparison signal CMP4 is output), a current may be supplied from the input terminal 11″ to the inductor L. In order to control the current of the inductor L according to the output voltage V_OUT, the control signal generator 330″ may generate the control signal CTRL based on the third and fourth comparison signals CMP3 and CMP4.

The control signal generator 330″ generates the control signal CTRL based on not only the first and second count signals CNT1 and CNT2, but also the third and fourth comparison signals CMP3 and CMP4, thereby compensating for variations in the output voltage V_OUT. For example, when the third comparison signal CMP3 is activated (e.g., the output voltage V_OUT is higher than the third reference voltage V_REF3), the control signal CTRL may be deactivated. Furthermore, when the fourth comparison signal CMP4 is activated (e.g., the output voltage V_OUT is lower than the fourth reference voltage V_REF4), the control signal generator 330″ may activate the control signal CTRL. Therefore, any abrupt variation in the output voltage V_OUT may be compensated for according to a condition of a load connected to the output terminal 12″. The operation of the controller 300″ due to the variation of the output voltage V_OUT will be described below with reference to the waveforms shown in FIG. 11.

FIGS. 10A and 10B are block diagrams showing examples 330a″ and 330b″ of a control signal generator 330″ of FIG. 9 according to at least one example embodiment of the inventive concepts. As described above with reference to FIGS. 8 and 9, the control signal generators 330a″ and 330b″ may generate the control signal CTRL based on not only the count signal CNT output by the count circuit 320″, but also the comparison signal CMP output by the comparison circuit 310″.

Referring to FIG. 10A, the control signal generator 330a″ may include first and second digital comparators 331a″ and 332a″, OR gates 333a″ and 334a″, and an RS latch 339a″, but is not limited thereto. The first digital comparator 331a″ may output an activated signal when the value of the first count signal CNT1 is equal to or greater than a desired threshold, such as the first reference count C_REF1, and a first OR gate 333a″ may generate an activated RS reset signal RS_R based on the output of the first digital comparator 331a″. Furthermore, the first OR gate 333a″ may also generate the activated reset signal RS_R in response to the activated third comparison signal CMP3. Additionally, the RS latch 339a″ may output the deactivated control signal CTRL in response to the activated RS reset signal RS_R.

Similarly, the second digital comparator 332a″ may output an activated signal when the value of the second count signal CNT2 is greater than or equal to a desired threshold, such as the second reference count C_REF2, and a second OR gate 334a″ may generate an activated RS set signal RS_S based on the output of the second digital comparator 332a″. Furthermore, the second OR gate 334a″ may also generate the activated RS set signal RS_S in response to the activated fourth comparison signal CMP4. Additionally, the RS latch 339a″ may output the activated control signal CTRL in response to the activated RS set signal RS_S.

Referring to FIG. 10B, the control signal generator 330b″ may include a plurality of AND gates 331b″ through 334b″, OR gates 335b″ and 336b″, and an RS latch 339b″, but is not limited thereto. A first AND gate 331b″ may receive the first count signal CNT1, where the first count signal may include a plurality of bits, and may output an activated signal when all of the bits of the first count signal CNT1 are activated. When both the output signal of the first AND gate 331b″ and the first comparison signal CMP1 are activated, a third AND gate 333b″ may output an activated signal and a first OR gate 335b″ may output an activated RS reset signal RS_R. Furthermore, the first OR gate 335b″ may generate the activated reset signal RS_R in response to the activated third comparison signal CMP3. Additionally, the RS latch 339b″ may output the deactivated control signal CTRL in response to the activated control signal RS_R.

Similarly, the second AND gate 332b″ may receive the second count signal CNT2, where the second count signal may include a plurality of bits, and when all of the bits of the second count signal CNT2 are activated, may output an activated signal. When both the output signal of the second AND gate 332b″ and the second comparison signal CMP2 are activated, a fourth AND gate 334b″ may output an activated signal, and a second OR gate 336b″ may output the activated RS set signal RS_S. Furthermore, the second OR gate 336b″ may generate the activated set signal RS_S in response to the activated fourth comparison signal CMP4. Additionally, the RS latch 339b″ may output the activated control signal CTRL in response to the activated RS set signal RS_S.

As described above with reference to FIGS. 4A and 4B, according to at least one example embodiment, the input signals of the RS latch 339a″, that is, the RS reset signal RS_R and the RS set signal RS_S, may be used to reset the count circuit 320″ of FIG. 9. For example, the RS reset signal RS_R may be input to the reset terminal of the first counter 321″, whereas the RS set signal RS_S may be input to the reset terminal of the second counter 322″. Therefore, when the value of a counter signal exceeds a reference number, the counter signal may be initialized, that is, set to ‘0’.

FIG. 11 shows a waveform diagram of the signals of FIGS. 8 and 9 according to at least one example embodiment of the inventive concepts. As described above with reference to FIGS. 8 and 9, the control signal CTRL may be generated based on not only the feedback voltage V_FB, but also the output voltage V_OUT. In FIG. 11, an activated signal is shown as having a higher level than a deactivated signal, and the first and second count signals CNT1 and CNT2 are shown as rising as more active pulses are counted. Furthermore, in FIG. 11, it is assumed that the values of the first and second reference counts C_REF1 and C_REF2 are both ‘6’, but C_REF1 and C_REF2 are not limited thereto, and FIG. 11 will be described below with reference to FIGS. 8 and 9.

Referring to FIG. 11, a current may be supplied to the inductor L from the input terminal 11″ in response to the control signal CTRL being activated from the time point t41 to the time point t42. As a result, the output voltage V_OUT may continuously rise. Due to the current supplied to the inductor L, the feedback voltage V_FB may rise and intersect with the first reference voltage V_REF1 (e.g., the feedback voltage V_FB is greater than or equal to the first reference voltage V_REF1). For example, the feedback voltage V_FB may rise and intersect with the first reference voltage V_REF1 at the time point t41, and thus the first comparison signal CMP1 may be activated. In response to the activated first comparison signal CMP1, the value of the first count signal CNT1 may increase. Similarly, the value of the first count signal CNT1 until the time point t42 and, as the value of the first count signal CNT1 exceeds the reference count C_REF1 (that is, ‘6’) at the time point t42, the control signal CTRL may be deactivated. Due to the deactivated control signal CTRL, the output voltage V_OUT may drop.

At a time point t43, the output voltage V_OUT may drop rapidly depending on a condition of a load connected to the output terminal 12″. For example, as some part included in a load connected to the output terminal 12″ of the switching regulator 10″ are turned on and/or start functions that need, for example, higher power, the power load may consume a high current, and thus the output voltage V_OUT of the output terminal 12″ may rapidly drop. Such a rapid variation of the output voltage V_OUT may cause a malfunction or a failure of the load. Therefore, it is necessary for the switching regulator 10″ to stably supply the output voltage V_OUT by compensating for the variation of the output voltage V_OUT.

Due to the condition(s) of the load, the output voltage V_OUT starts to drop at the time point t43 and may intersect with the second reference voltage V_REF2 at a time point t44, where the feedback voltage V_FB may become lower than the second reference voltage V_REF2. Therefore, the second comparison signal CMP2 may be kept active from the time point t44 as shown in FIG. 11. Since the value of the second count signal CNT2 does not exceed the second reference count C_REF2, the control signal CTRL may not be activated by the second count signal CNT2.

At a time point t45, the output voltage V_OUT may intersect with the fourth reference voltage V_REF4. Therefore, the fourth comparison signal CMP4 may be activated, and the control signal CTRL may be activated in response to the activated fourth comparison signal CMP4. A current may be supplied from the input terminal 11″ to the inductor L due to the activated control signal CTRL, and the output voltage V_OUT may rise again as shown in FIG. 11. Therefore, a variation of the output voltage V_OUT may be compensated for and the output voltage V_OUT may be adjusted to be between the third and fourth reference voltages V_REF3 and V_REF4 (e.g., within a desired voltage range).

Although the first through fourth reference voltages V_REF through V_REF4 are different from one another in the example embodiment shown in FIG. 11, at least two of the first through fourth reference voltages V_REF1 through V_REF4 may be identical to each other, according to at least one example embodiment of the inventive concepts. For example, the first reference voltage V_REF1 may be identical to the third reference voltage V_REF3, whereas the second reference voltage V_REF2 may be identical to the fourth reference voltage V_REF4, but the example embodiments are not limited thereto.

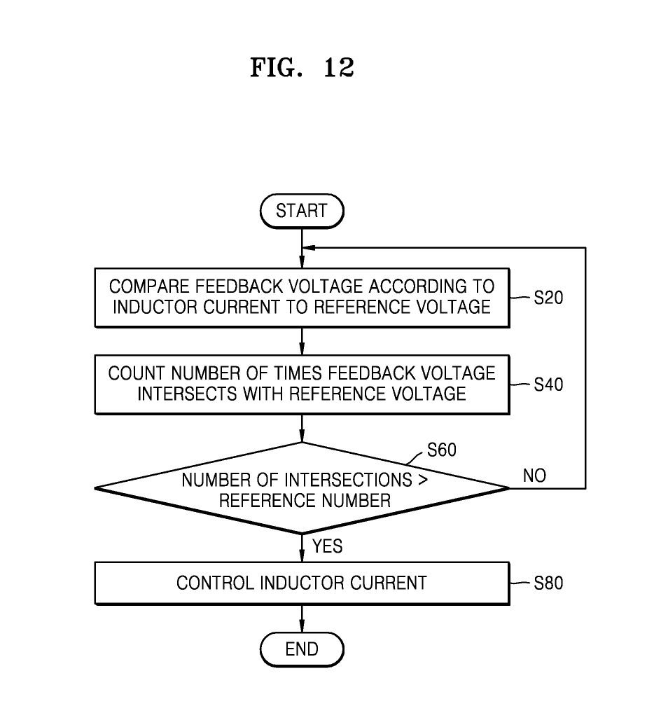

FIG. 12 is a flowchart of a method of controlling a switching regulator according to at least one example embodiment of the inventive concepts. As shown in FIG. 12, the method of controlling the switching regulator may include a plurality of operations, such as S20, S40, S60, and S80. According to at least one example embodiment of the inventive concepts, the method of controlling the switching regulator of FIG. 12 may be performed by the controller 300 of FIG. 1. Descriptions of FIG. 12 will be given below with reference to FIG. 1.

In operation S20, an operation for comparing a feedback voltage according to an inductor current to a reference voltage may be performed. For example, in FIG. 1, the feedback voltage V_FB may be provided by the RC circuit 200 that is connected to the inductor L in parallel to detect a current flowing through the inductor L (that is, the inductor current). In detail, the feedback voltage V_FB may be a voltage of a feedback node connected to a sense resistor R_SEN and a sense capacitor C_SEN included in the RC circuit 200, where a current flowing through the inductor L may be detected according to magnitude of the feedback voltage V_FB. The feedback voltage V_FB may be compared to at least one reference voltage in the comparison circuit 310 of the controller 300, and the comparison circuit 310 may generate the comparison signal CMP according to a result of the comparison.

In operation S40, an operation for counting the number of times a feedback voltage intersects with a reference voltage (e.g., a desired threshold voltage) may be performed. For example, in FIG. 1, the count circuit 320 of the controller 300 may count the number of times the feedback voltage V_FB intersects with at least one reference voltage (e.g., at least one desired threshold voltage) based on the comparison signal CMP provided from the comparison circuit 310. For example, the count circuit 320 may count the number of times that the feedback voltage V_FB intersects with the first reference voltage as the feedback voltage V_FB rises and/or the number of times that the feedback voltage V_FB intersects with the second reference voltage as the feedback voltage V_FB drops.

In operation S60, an operation for comparing the number of intersections to a reference number (e.g., a desired threshold value) may be performed. For example, in FIG. 1, the control signal generator 330 may compare the number of times the feedback voltage V_FB intersects with a reference voltage to a reference number based on the count signal CNT provided by the count circuit 320. The reference number may be set based on a signal received from the outside of the switching regulator 10 (e.g., an external source) or may be set to a certain desired value inside the control signal generator 330.

When the number of intersections does not exceed the reference number, an operation for comparing a feedback voltage to a reference voltage (e.g., desired threshold feedback voltage) is performed in operation S20. On the contrary, when the number of intersections exceeds the reference number, an operation for controlling an inductor current is performed in operation S80. For example, in FIG. 1, when the number of times the feedback voltage V_FB intersects with a reference voltage as the feedback voltage V_FB rises exceeds a reference number (e.g., a desired threshold feedback voltage number), the control signal generator 330 may activate the control signal CTRL, and the switching circuit 100 may supply a current from the input terminal 11 to the inductor L in response to the activated control signal CTRL. Furthermore, when the number of times the feedback voltage V_FB intersects with the reference voltage as the feedback voltage V_FB drops below the reference voltage exceeds a reference number, the control signal generator 330 may deactivate the control signal CTRL, and the switching circuit 100 may allow a current to flow from the inductor L to the ground in response to the deactivated control signal CTRL.

As described above, according to the method of controlling a switching regulator, an inductor current may be controlled based on the number of times a feedback voltage intersects with a reference voltage. Therefore, a property value (e.g., capacitance) and physical size of a circuit element (e.g., the sense capacitor C_SEN of FIG. 1) included the switching regulator may be reduced.

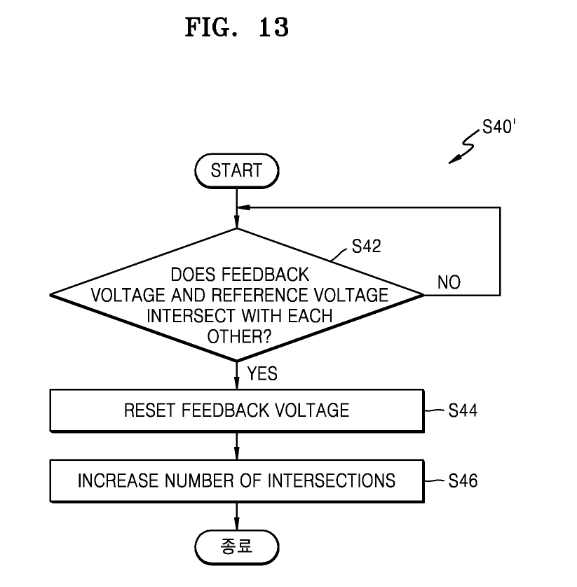

FIG. 13 is a flowchart of an example S40′ of operation S40 of FIG. 12 according to at least one example embodiment of the inventive concepts. As described above with reference to FIG. 12, an operation for counting the number of times a feedback voltage intersects with a reference voltage may be performed in operation S40. According to at least one example embodiment of the inventive concepts, operation S40′ of FIG. 13 may be performed by the controller 300′ of FIG. 5. Hereinafter, FIG. 13 will be described with reference to FIG. 5.

Referring to FIG. 13, an operation for determining whether a feedback voltage intersects with a reference voltage may be performed in operation S42. For example, the comparison circuit 310′ of FIG. 5 may output the comparison signal CMP by comparing the feedback voltage V_FB to a reference voltage and, based on the comparison signal CMP, it may be determined whether the feedback voltage V_FB intersects with the reference voltage.

When the feedback voltage does not intersect with the reference voltage, the method may perform the determination again in operation S42 of whether the feedback voltage intersects with the reference voltage. When the feedback voltage intersects with the reference voltage, an operation for resetting the feedback voltage may be performed in operation S44. For example, the reset signal generator 350′ of FIG. 5 may generate the activated reset signal RST based on the comparison signal CMP provided by the comparison circuit 310′, and the reset switch 340′ may reset the feedback voltage V_FB to the voltage value of the output voltage V_OUT in response to the activated reset signal RST. Therefore, an offset of the output voltage V_OUT caused by charges accumulated differently in the sense capacitor C_SEN according to the conditions of a load connected to the output terminal 12′ may be eliminated. Furthermore, as the feedback voltage V_FB is reset to the voltage value of the output voltage V_OUT, the comparison signal CMP of the comparison circuit 310′ may have a pulse that is activated and then deactivated according to a result of a comparison.

In operation S46, an operation for increasing the number of intersections may be performed. For example, the counter circuit 320′ of FIG. 5 may increase the number of intersections based on a comparison signal provided by the comparison circuit 310′ and may output the count signal CNT corresponding to the increased number of intersections.

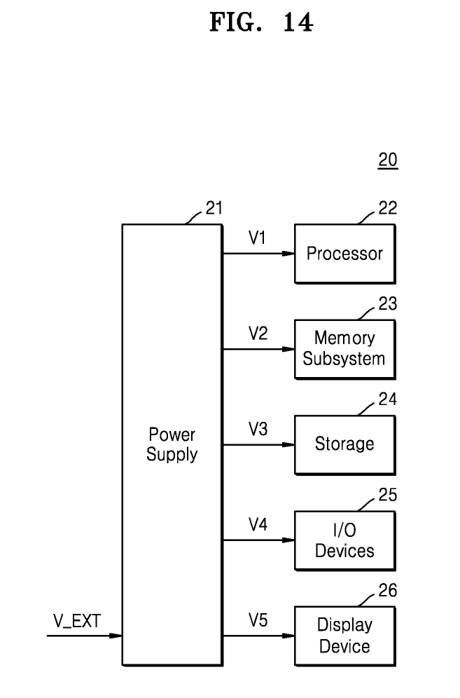

FIG. 14 is a block diagram of a system 20 including a switching regulator according to at least one example embodiment of the inventive concepts. As shown in FIG. 14, the system 20 includes a power supply 21, at least one processor 22, a memory sub-system 23, a storage device 24, input/output devices 25, and a display device 26, but is not limited thereto.

The at least one processor 22 may perform certain calculations and/or tasks. For example, the processor 22 may control a switching regulator included in the power supply 21 to set a reference number to be compared to the number of times a feedback voltage intersects with a reference voltage. The processor 22 may be, for example and without limitation, at least one microprocessor and/or at least one application processor and may communicate with other components of the system 20 via a bus. The processor 22 may be a multi-core or a multi-processor, a distributed processing system, etc. The memory sub-system 23 and the storage 24 may store data necessary for operations of the system 20. For example, the memory sub-system 23 may include a volatile memory device, such as DRAM, SRAM, and mobile DRAM, and/or a non-volatile memory device, such as flash memory, EEPROM, PRAM, RRAM, MRAM, and FRAM. The storage device 24 may also include a non-volatile memory device and/or a non-transitory storage medium, such as a solid state drive (SSD), a hard disk drive (HDD), and a CD-ROM/DVD/Blu-ray, etc. The input/output devices 25 may include input devices, such as a keyboard, a keypad, a touch pad, a touch screen, a stylus, a microphone, a camera, a mouse, etc., and may include output devices, such as a speaker, a haptic feedback device, a printer, etc. The display device 1600 may include a liquid crystal display (LCD) device, an organic light emitting display (OLED) device, etc.

The power supply 21 may generate power supply voltages, e.g., V1 through V5, based on an external voltage V_EXT and may supply the power supply voltages, e.g., V1 through V5, to the other components of the system 20, that is, the processor 22, the storage 24, the input/output devices 25, and the display device 26, etc. For example, the system 20 may include a battery and a voltage supplied to the power supply 21 may be a battery voltage provided by the battery. In another example, the system 20 may receive power from the outside (e.g., an external source) via a power line, and the external voltage V_EXT may be a voltage generated from the power supplied via the power line. In other words, the external voltage V_EXT may be an AC voltage of a power line and/or a DC voltage generated by rectifying an AC voltage supplied from the power line.

The power supply 21 may include a switching regulator according to at least one example embodiment of the inventive concepts that generates at least one of the power supply voltages, e.g., V1 through V5. In other words, the switching regulator included in the power supply 21 may count the number of times a feedback voltage for sensing a current flowing through an inductor intersects with a reference voltage and, when the number of times the feedback voltage intersects with the reference voltage exceeds a reference number, may control the current flowing through the inductor. Therefore, the physical sizes of various circuit elements included in the switching regulator may be reduced, and thus the physical size of the power supply 21 may also be reduced.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

1. A controller of a switching regulator, wherein the switching regulator includes an inductor connected to at least one output terminal of the switching regulator, a switching circuit configured to supply a current from at least one input terminal of the switching regulator to the inductor based on a control signal, and an RC circuit comprising at least one sense resistor connected in series to at least one sense capacitor and a feedback node, the RC circuit connected in parallel to the inductor; and the controller comprising:
a first comparator configured to generate a first comparison signal based on a voltage of the feedback node and a first reference voltage;
a first counter configured to count active pulses of the first comparison signal; and
a control signal generator configured to generate the control signal based on a value of an output signal of the first counter and a first reference value;
a reset signal generator confirmed to generate a reset signal based on the first comparison signal; and
a reset switch configured to reset the sense capacitor by interconnecting both ends of the sense capacitor based on the reset signal,
wherein the sense capacitor is reset more frequently than the first counter.

2. The controller of claim 1, wherein the first reference value is inversely proportional to a capacitance of the sense capacitor.

3. The controller of claim 1, further comprising:
a second comparator configured to generate a second comparison signal based on the voltage of the feedback node and a second reference voltage that is less than the first reference voltage; and
a second counter configured to count active pulses of the second comparison signal; and
wherein the control signal generator is further configured to generate the control signal based on an output signal of the second counter and a second reference value.

4. The controller of claim 3, wherein the reset signal generator is configured to generate the reset signal based on the first comparison signal and the second comparison signal.

5. The controller of claim 3, further comprising:
a third comparator configured to generate a third comparison signal based on a voltage of the output terminal and a third reference voltage; and
wherein the control signal generator is further configured to generate the control signal based on the third comparison signal.

6. The controller of claim 5, further comprising:
a fourth comparator configured to generate a fourth comparison signal based on the voltage of the output terminal and a fourth reference voltage that is less than the third reference voltage; and
wherein the control signal generator is further configured to generate the control signal based on the fourth comparison signal.

7. The controller of claim 6, wherein
the third reference voltage is greater than the first reference voltage; and
the fourth reference voltage is less than the second reference voltage.

8. A switching regulator comprising:
an inductor connected to an output terminal;
an RC circuit connected in parallel to the inductor, the RC circuit comprising at least one sense resistor in series with at least one sense capacitor and a feedback node;
a switching circuit configured to supply a current from an input terminal to the inductor based on a control signal; and
a controller configured to reset the at least one sense capacitor by interconnecting both ends of the sense capacitor and generate the control signal based on a number of times a voltage of the feedback node intersects at least one reference voltage,
wherein the controller is further configured to reset the at least one sense capacitor more frequently than a number of times that the voltage of the feedback node intersects at least one reference voltage is reset.

9. The switching regulator of claim 8, wherein, when the number of times the voltage of the feedback node intersects at least one reference voltage is greater than a reference number, the controller is further configured to activate or deactivate the control signal.

10. The switching regulator of claim 9, wherein the reference number is inversely proportional to a capacitance of the sense capacitor.

11. The switching regulator of claim 9, wherein the controller comprises:
a comparison circuit configured to,
generate a first comparison signal based on the voltage of the feedback node and a first reference voltage, and
generate a second comparison signal based on the voltage of the feedback node and a second reference voltage, the second reference voltage being less than the first reference voltage;
a counter circuit configured to count active pulses of each of the first and second comparison signals; and
a control signal generator configured to generate the control signal based on an output signal of the counter circuit and the reference number.

12. The switching regulator of claim 11, wherein the control signal generator is further configured to:
deactivate the control signal when a number of active pulses of the first comparison signal is greater than a first reference number; and
activate the control signal when a number of active pulses of the second comparison signal is greater than a second reference number.

13. The switching regulator of claim 11, wherein the controller is further configured to activate or deactivate the control signal when a voltage of the output terminal intersects at least one reference voltage.

14. The switching regulator of claim 9, wherein the controller is further configured to set the reference number based on an external signal received by the switching regulator.

15. The switching regulator of claim 8, wherein
the controller further comprises a reset signal generator and a reset switch; and
reset signal generator is configured to generate the reset signal based on the voltage of the feedback node and at least two reference voltage.

16. A switching regulator for a power supply, the switching regulator comprising:
an RC circuit configured to detect a current flowing through an inductor and transmit a feedback voltage based on the detected current, the RC circuit including at least one sense resistor and at least one sense capacitor, the RC circuit in parallel with an inductor, and the inductor further connected to an output terminal, an output capacitor, and a switching circuit;
a controller configured to reset the at least one sense capacitor by interconnecting both ends of the sense capacitor and generate a control signal based on a number of times that the feedback voltage deviates from a desired voltage range, the desired voltage range defined by at least one reference voltage; and
the switching circuit is configured to control the inductor based on the generated control signal, the controlling including supplying a current from an input terminal to the inductor based on the generated control signal,
wherein the controller is further configured to reset the at least one sense capacitor more frequently than a number of times that the feedback voltage deviates from the desired voltage range is reset.

17. The switching regulator of claim 16, wherein the controller is further configured to:
count a number of times that the feedback voltage deviates from the desired voltage range, the desired voltage range defined by two reference voltages;
determine whether the counted number exceeds a desired reference number; and
wherein the generate the control signal includes,
activating the control signal when the determination indicates that the counted number exceeds the desired reference number, and
continue counting the number of times that the feedback voltage deviates from the desired voltage range when the determination indicates that the counted number does not exceed the desired reference number.

18. The switching regulator of claim 17, wherein the controller is further configured to:
reset the feedback voltage to a voltage value of an output voltage of the output terminal when the feedback voltage deviates from the desired voltage range.

19. The switching regulator of claim 17, wherein the desired reference number is set by an external source.

20. The switching regulator of claim 16, wherein the switching regulator is a DC-to-DC power converter and the switching regulator is included in the power supply.
